(19) United States
(12) Patent Application Publication
(10) Pub. No.: US 2021/0279180 A1
(43) Pub. Date: Sep. 9, 2021

(54) APPARATUS AND METHOD FOR CONTROLLING MAP DATA IN A MEMORY SYSTEM

(71) Applicant: SK hynix Inc., Gyeonggi-do (KR)

(72) Inventor: Gi Pyo UM, Gyeonggi-do (KR)

(21) Appl. No.: 16/990,562

(22) Filed: Aug. 11, 2020

(30) Foreign Application Priority Data
Mar. 5, 2020 (KR) 10-2020-0027666

(51) Int. Cl. G06F 12/10

(52) U.S. Cl. CPC G06F 12/10; G06F 2212/657

(57) ABSTRACT

A memory system include a memory device including a plurality of non-volatile memory cells, and a controller configured to determine a pattern regarding a plurality of data input/output requests, control map data to have a data structure based on the pattern, and program map information included in the map data into the memory device. A timing of programming the map information can be based on the data structure of the map data.

### CROSS-REFERENCE TO RELATED APPLICATIONS

This patent application claims the benefit of Korean Patent Application No. 10-2020-0027666, filed on Mar. 5, 2020, the entire disclosure of which is incorporated herein by reference.

### TECHNICAL FIELD

One or more embodiments described herein relate to an apparatus and method for controlling information in a memory system.

### BACKGROUND

Recently, a paradigm for a computing environment has shifted to ubiquitous computing, which enables computer systems to be accessed virtually anytime and anywhere. As a result, the use of portable electronic devices (e.g., mobile phones, digital cameras, notebook computers) are rapidly increasing. Such portable electronic devices may use or include a memory system having at least one memory device, e.g., a data storage device. The data storage device can be used as a main storage device or an auxiliary storage device of a portable electronic device.

Unlike a hard disk, data storage devices that use non-volatile semiconductor memories exhibit improved stability and durability, have no mechanical driving parts (e.g., a mechanical arm), and perform with high data access speeds and relatively low power consumption. Examples of these types of data storage devices include, but are not limited to, Universal Serial Bus (USB) memory devices, memory cards having various interfaces, and solid state drives (SSDs).

### BRIEF DESCRIPTION OF THE DRAWINGS

The description herein makes reference to the accompanying drawings wherein like reference numerals refer to like parts throughout the figures.

FIG. 1 illustrates a memory system according to an embodiment.

FIG. 2 illustrates a data processing system according to an embodiment.

FIG. 3 illustrates a memory system according to an embodiment.

FIGS. 4A to 4C illustrate data structures of map data according to one or more embodiments.

FIG. 5 illustrates space change allocated for map data in a volatile memory according to an embodiment.

FIG. 6 illustrates data input/output operations performed by a memory system according to an embodiment.

FIG. 7 illustrates a first example of a method for operating a memory system according to an embodiment.

FIG. 8 illustrates a method for operating a memory system according to another embodiment.

FIG. 9 illustrates a method for operating a memory system according to another embodiment.

FIG. 10 illustrates a method for operating a memory system according to another embodiment.

In this disclosure, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

### DETAILED DESCRIPTION

Various embodiments of the disclosure are described below with reference to the accompanying drawings. Elements and features of the disclosure, however, may be configured or arranged differently to form other embodiments, which may be variations of any of the disclosed embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim does not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language include hardware-for example, circuits, memory storing program instructions executable to implement the operation, etc. Reciting that a block/unit/circuit/component is “configured to” perform one or more tasks is expressly intended not to invoke 35 U.S.C. § 112, sixth paragraph, for an interpretation of the block/unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used in the disclosure, the term ‘circuitry’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” also covers an implementation of merely a processor (or multiple processors) or portion of a processor and its (or their) accompanying software and/or firmware. The term “circuitry” also covers, for example, and if applicable to a particular claim element, an integrated circuit for a storage device.

As used herein, these terms “first,” “second,” “third,” and so on are used as labels for nouns that they precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the disclosure can provide a data process system and a method for operating the data processing system, which includes components and resources such as a memory system and a host and is capable of dynamically allocating plural data paths used for data communication between the components based on usages of the components and the resources.

Various embodiments described herein provide a method and apparatus for changing a data structure for map information in a way that, for example, may improve data input/output performance of a memory system based on a type of data input/output operations. This may produce a commensurate reduction in resources used to perform data input/output operations and may improve operational efficiency. In one embodiment, a memory system may be provided which selects a data structure for the map information in response to a request or a type of data input from an external device, and may change the timing of programming the map information into a memory device including a plurality of non-volatile memory cells.

According to an embodiment, the memory system may reduce consumption of resources such as a cache memory allocated and used for internal processes such as address translation and map information management. Additionally, or alternatively, the memory system may use or re-distribute much more available resources for the data input/output operations corresponding to requests input from the external device in order to improve data input/output performance of the memory system.

In an embodiment, a memory system can include a memory device including a plurality of non-volatile memory cells; and a controller configured to determine a pattern regarding a plurality of data input/output requests, control map data to have a data structure based on the pattern, and program map information included in the map data into the memory device. A timing of programming the map information can be based on the data structure of the map data.

The pattern can indicate that the plurality of data input/output requests correspond to sequential data or random data.

The map data can include a piece of second map information that links a physical address with a logical address, wherein the second map information is distinguished from a piece of first map information, stored in the memory device, for linking a logical address to a physical address.

The data structure can include one of: a first structure including plural pieces of map information, each piece of map information associating a single physical address with a single logical address; a second structure including plural pieces of map information, each piece of map information associating a single physical address with a start address and a continuous count of plural logical addresses or associating a single logical address with a start address and a continuous count of plural physical addresses; and a third structure including a combination of the first structure and the second structure.

The memory device can be configured to store first map data, the first map data including a Logical to Physical (L2P) table, the L2P table including plural pieces of first map information. The controller can be configured to load the first map data into a memory and perform address translation regarding a logical address input with one or more of the plurality of data input/output requests. The controller can be configured to update the first map data, stored in the memory device, based on second map data including a Physical to Logical (P2L) table, the P2L table including plural piece of second map information.

The controller can be configured to: allocate a region having a set size in a memory to store the map data, and program the map information into the memory device after the region is fully filled with map information.

The controller can be configured to: change the data structure based on the pattern, and program the map information, included in the map data before the data structure is changed, in the memory device after changing the data structure.

The controller can be configured to determine the pattern corresponding to the plurality data input/output requests after programming the map information in the memory device.

In another embodiment, a method for operating a memory system can include determining a pattern regarding a plurality of data input/output requests; controlling map data to have a data structure based on the pattern; and programming map information included in the map data into a memory device including a plurality of non-volatile memory cells, wherein a timing of programming the map information is based on the data structure of the map data.

The pattern can indicate that the plurality of data input/output requests correspond to sequential data or random data.

The map data can include a piece of second map information that links a physical address with a logical address, wherein the second map information is distinguished from a piece of first map information, stored in the memory device, for linking a logical address to a physical address.

The data structure can include one of: a first structure including plural pieces of map information, each piece of map information associating a single physical address with a single logical address; a second structure including plural pieces of map information, each piece of map information associating a single physical address with a start address and a continuous count of plural logical addresses or associating a single logical address with a start address and a continuous count of plural physical addresses; and a third structure including a combination of the first structure and the second structure.

The method can further include storing first map data, the first map data including a Logical to Physical (L2P) table, the L2P table including plural pieces of first map information; loading the first map data into a memory and performing address translation regarding a logical address input with one or more of the plurality of data input/output requests; and updating the first map data, stored in the memory device, based on second map data including a Physical to Logical (P2L) table, the P2L table including plural pieces of second map information.

The method can further include allocating a region having a set size in a memory for storing the map data; and programming the map information into the memory device after the region is fully filled with map information.

The method can further include changing the data structure based on the pattern; and programming the map information, included in the map data before the data structure is changed, in the memory device after changing the data structure.

The method can further include determining the pattern regarding the plurality of data input/output requests after programming the map information in the memory device.

In another embodiment, a controller can control first map information and second map information used to associate different addresses with each other to engage plural devices that use different address systems. The controller can be configured to: determine a pattern regarding a plurality of data input/output requests; select a data structure of map data based on the pattern, the data structure used to store a piece of second map information corresponding to a subsequent write operation; update a piece of first map information based on the piece of second map information, wherein the piece of second map information corresponds to another write operation which has been performed; and store the piece of second map information in the second map data having the selected data structure.

The piece of first map information associates a logical address with a physical address, and the piece of second map information associates the physical address with the logical address.

The data structure can include one of: a first structure including plural pieces of map information, each piece of map information associating a single physical address with a single logical address; and a second structure including plural pieces of map information, each piece of map information associating a single physical address with a start address and a continuous count of plural logical addresses or associating a single logical address with a start address and a continuous count of plural physical addresses.

The piece of first map information can be updated when no more a piece of second map information is added into the second map data.

In another embodiment, an apparatus for managing storage of information can include a storage area configured to store map information; and a processor configured to execute instructions in order to: determine a pattern corresponding to data input/output requests; change a first data structure of the map information to a second data structure based on the pattern; and update the map information in the storage area based on the change to the second data structure, wherein the pattern is one of random data or sequential data.

Embodiments of the disclosure will now be described with reference to the accompanying drawings, wherein like numbers reference like elements.

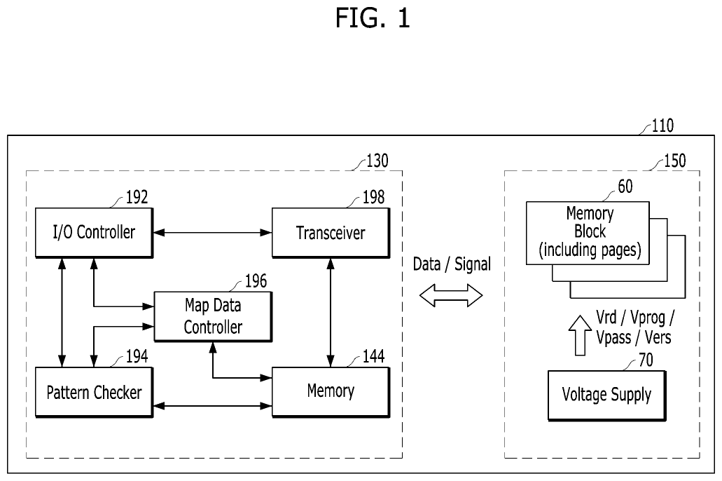

FIG. 1 illustrates an embodiment of a memory system 110 which may include a memory device 150 and a controller 130. The memory device 150 and the controller 130 in the memory system 110 may be considered components or elements physically separated from each other. The memory device 150 and the controller 130 may be connected via at least one data path. For example, the data path may include a channel and/or a way. According to an embodiment, the memory device 150 and the controller 130 may be components or elements functionally divided. Further, according to an embodiment, the memory device 150 and the controller 130 may be implemented with a single chip or a plurality of chips.

The memory device 150 may include a plurality of memory blocks 60. The memory block 60 may be understood as a group of non-volatile memory cells in which data is removed together by a single erase operation. The memory block 60 may include a plurality of pages. According to an embodiment, each page may be understood as a group of non-volatile memory cells that store data together during a single program operation or output data together during a single read operation.

The memory device 150 may include a plurality of memory planes or a plurality of memory dies. According to an embodiment, the memory plane may be considered a logical or a physical partition including at least one memory block 60, a driving circuit capable of controlling an array including a plurality of non-volatile memory cells, and a buffer that can temporarily store data input to, or output from, non-volatile memory cells.

In addition, according to an embodiment, the memory die may include at least one memory plane. The memory die may be understood as a set of components implemented on a physically distinguishable substrate. Each memory die may be connected to the controller 130 through a data path. Each memory die may include an interface to exchange a piece of data and a signal with the controller 130.

According to an embodiment, the memory device 150 may include at least one memory block 60, at least one memory plane, or at least one memory die. The internal configuration of the memory device 150 shown in FIG. 1 may be different according to performance of the memory system 110. An embodiment of the disclosure is not limited to the internal configuration shown in FIG. 1.

Referring to FIG. 1, the memory device 150 may include a voltage supply circuit 70 capable of supplying at least one type of voltage into the memory block 60. In one embodiment, the voltage supply circuit 70 may supply a read voltage Vrd, a program voltage Vprog, a pass voltage Vpass, and/or an erase voltage Vers into a non-volatile memory cell included in the memory block 60. For example, during a read operation for reading data stored in the non-volatile memory cell included in the memory block 60, the voltage supply circuit 70 may supply the read voltage Vrd into a selected non-volatile memory cell. During the program operation for storing data in the non-volatile memory cell included in the memory block 60, the voltage supply circuit 70 may supply the program voltage Vprog into a selected non-volatile memory cell. Also, during a read operation or a program operation performed on the selected non-volatile memory cell, the voltage supply circuit 70 may supply a pass voltage Vpass into a non-selected non-volatile memory cell. During the erasing operation for erasing data stored in the non-volatile memory cell included in the memory block 60, the voltage supply circuit 70 may supply the erase voltage Vers into the memory block 60.

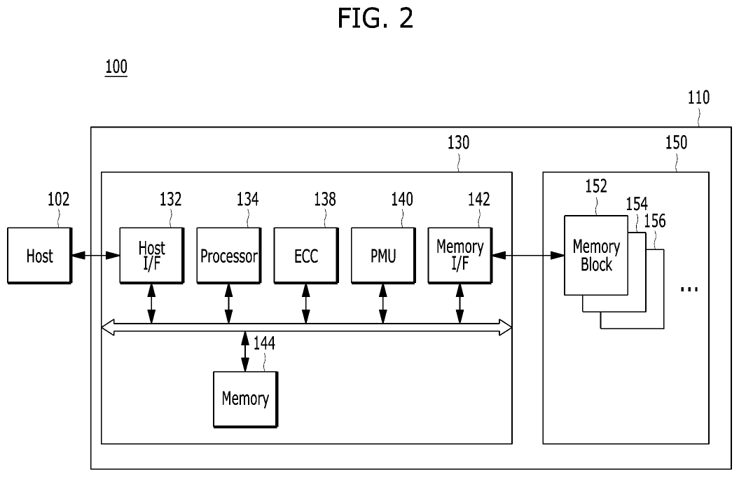

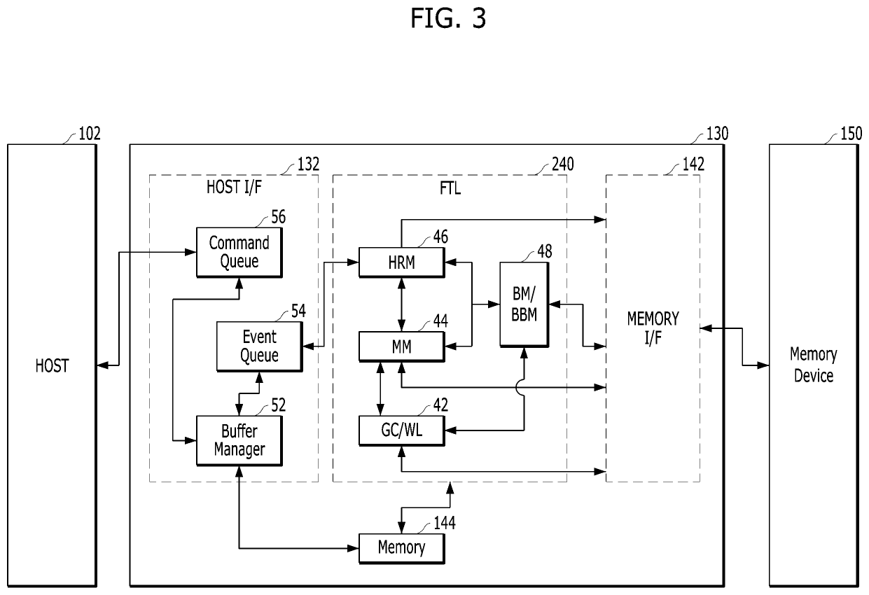

In order to store data requested by an external device (see, e.g., host 102 in FIGS. 2-3) in the memory device 150 (e.g., a storage space including non-volatile memory cells), the memory system 110 may perform address translation between a file system used by the host 102 with a physical location of the storage space including the non-volatile memory cells. For example, a data address determined according to the file system used by the host 102 may be called a logical address or a logical block address, while an address for the physical location at which data is stored in the storage space may be referred as to a physical address or a physical block address. When the host 102 transfers a logical address to the memory system 110 together with a read request, the memory system 110 searches for a physical address associated with the logical address, reads data stored in a location recognized by the physical address, and outputs read data to the host 102. During this procedure, address translation may be performed in the memory system 110 to search for the physical address associated with the logical address input from the host 102.

The controller 130 may perform a data input/output operation in response to a request input from the external device. For example, when the controller 130 performs a read operation in response to a read request input from an external device, data stored in a plurality of non-volatile memory cells included in the memory device 150 is transferred to the controller 130. For the read operation, the input/output controller 192 may perform address translation to the logical address input from the external device to obtain a physical address, and then transmit a read command to the memory device 150 corresponding to the physical address through the transceiver 198. The transceiver 198 may transmit the read command to the memory device 150 and receive data output from the memory device 150 corresponding to the physical address. The transceiver 198 may store data transferred from the memory device 150 in the memory 144. The input/output controller 192 may output data stored in the memory 144 to the external device in response to the read request.

In addition, the input/output controller 192 may transmit user data input along with a write request from the external device to the memory device 150 through the transceiver 198. After storing the data in the memory device 150, the input/output controller 192 may transmit a response corresponding to the write request to the external device. The I/O controller 192 may update map data that associates the physical address, which indicates a location where the user data in the memory device 150 is stored, with the logical address input along with the write request.

When the input/output controller 192 performs the data input/output operation, the pattern checker 194 may determine an operation pattern regarding read/write requests and plural pieces of input/output data input from the external device. For example, the pattern checker 194 may determine whether plural read requests transmitted by an external device are associated with sequential data or random data. When the pattern checker 194 determines a pattern regarding operations performed in the memory system 110, the input/output controller 192 may schedule operations corresponding to a plurality of requests requested by an external device based on the pattern. For example, when mixed requests for sequential data and random data are input, the input/output controller 192 may classify or arrange each of the mixed requests based on the pattern determined by the pattern checker 194, in order to adjust or change the sequence of operations performed corresponding to the mixed requests. In one embodiment, when plural requests for sequential data and random data are mixed, the input/output controller 192 may perform operations corresponding to some of the plural requests regarding the sequential data earlier than operations corresponding to other of the plural requests regarding the random data, to improve data input/output performance of the memory system 110.

The map data controller 196 may determine the data structure of map data used by the controller 130, based on a pattern regarding a plurality of requests determined by the pattern checker 194. The map data may include plural pieces of map information, each of which may associate a logical address with a physical address, or vice versa, which is used as operation information for a data input/output operation performed by the controller 130. For example, the I/O controller 192 may use an piece of map information for address translation, and pieces of map information may be updated or generated after data corresponding to a write request is programmed in the memory device 150. According to an embodiment, the map data may be classified into first map data (e.g., Logical to Physical(L2P) table) for associating a logical address with a physical address and second map data (e.g., Physical to Logical (P2L) table) for associating a physical address with a logical address. The map data controller 196 may determine or change the data structure for the first map data or the second map data loaded or generated in the memory 144.

According to an embodiment, a piece of map information included in the first map data or the second map data stored in the memory device 150 may be stored to associate a single logical address with a single physical address. Plural pieces of map information may constitute a single map segment. The map segment may be considered a unit of which map data stored in the memory device 150 is composed. After the controller 130 loads and stores at least some portion of the first map data or the second map data from the memory device 150 in the memory 144, the controller 130 may utilize loaded information for data input/output operations. When there is sufficient space temporarily allocated for the first map data and the second map data in the memory 144, a process of changing a data structure or shape for the first map data or the second map data may cause unnecessary overhead. However, the storage capacity of the memory 144 in the memory system 110 may be limited. When the space allocated for temporarily storing the first map data and the second map data including plural pieces of map information is reduced, more space in the memory 144 may be allocated and used for other purposes such as data I/O operations.

According to an embodiment, the first map data (e.g., L2P table) including plural pieces of a piece of first map information (e.g., Logical to Physical (L2P) information) for associating a logical address with a physical address may be stored in the memory device 150. But, the controller 130 may generate second map data (P2L table) including plural pieces of a piece of second map information (e.g., Physical to Logical (P2L) information) generated through plural data input/output operations for associating the physical address with the logical address.

For example, after the controller 130 programs a new piece of user data to the memory device 150, the controller 130 may generate a piece of second map information (P2L) for linking a physical address (which indicates the location where the new piece of user data is programmed) to a logical address input from the host 102 and corresponding to the new piece of user data. The piece of a piece of second map information P2L in the memory 144 may provide an indication of a recent location regarding data stored in the memory device 150. In one case, it may be assumed that a piece of first map information L2P indicates that a specific logical address (e.g., ‘0A0’) and a first physical address (e.g., ‘123’) are associated with each other in the first map data (L2P table) loaded in the memory 144.

After the controller 130 performs a program operation regarding new data corresponding the same logical address (e.g., ‘0A0’), the controller 130 may generate a piece of second map information (P2L) in the memory 144. The piece of second map information (P2L) may associate the logical address (e.g., ‘0A0’) with a second physical address (e.g., ‘876’), indicating the location where the new data is stored by the program operation. In this case, the controller 130 may recognize that the piece of first map information L2P stored in the first map data (L2P table) is old and the piece of second map information P2L is the latest, i.e., most recent, map information. The controller 130 can update the first map data (L2P table) stored in the memory device 150 based on the piece of second map information P2L.

As described above, the controller 130 may perform a map flush (e.g., an operation for updating the first map data (L2P table) stored in the memory device 150) periodically, intermittently, or as needed. After the map flush is performed, the second map data P2L table including the piece of second map information P2L in the memory 144 may be deleted or destroyed. When an operation for programming data in the memory device 150 is performed after the map flush is performed, the controller 130 may generate new second map data (P2L table).

The timing for performing the map flush may be determined differently according to embodiments. For example, when the controller 130 performs 10 program operations, the controller 130 may determine that the map flush should be performed. For example, when a space allocated for the second map data (P2L table) is full and new a piece of second map information P2L cannot be added in the space, the controller 130 may determine that the map flush should be performed. For example, according to an embodiment, the controller 130 may determine that the map flush is performed every predetermined period (e.g., 1 hour, 10 minutes, 1 minute, or etc.).

A map flush is an operation that may be performed in the memory system 110, for example, when the memory system 110 has an independent address system (e.g., a physical address distinguishable from a logical address) that is not adopted by an external device such as the host 102. The external device does not have to request a map flush at the memory system 110. The memory system 110 performs the map flush independently, so that data input/output operations may be delayed during the map flush. The map flush in the memory system 110 may be recognized as overheads from a perspective of the external device. Thus, when the map flush occurs too frequently, data input/output performance may be deteriorated.

On the other hand, if a map flush has been not performed for a long time, the amount of invalid map information (which is no longer used for address translation) may increase in the first map data (L2P table) stored in the memory device 150. In this case, operation safety of the memory system 110 may be deteriorated, and the amount or frequency of map information that the controller 130 should check map data for performing address translation associated with a read request may increase. When the first map data (L2P table) does not include recent map information, the controller 130 may refer to the second map data (P2L table) stored in the memory 144 for address translation. Also, if a map flush has been not performed for a long time, the amount of the second map data (P2L table) stored in the memory 144 may increase and usage efficiency of the memory 144 may be deteriorated.

Referring to FIG. 1, the map data controller 196 may determine a data structure of second map data (P2L table) stored in the memory 144 based on the pattern regarding a plurality of requests input from an external device. The controller 130 may allocate a set sized space of the memory 144 for the second map data (P2L table). When the map data controller 196 changes the data structure of the second map data (P2L table), a time point when the space allocated for the second map data (P2L table) is filled with plural pieces of map information may be different. When it is established that the map flush is performed when the space for the second map data (P2L table) is full, the time at which the map flush is performed may be changed based on the data structure of the second map data (P2L table).

For example, when a plurality of requests input from an external device is related to sequential data, the map data controller 196 may change the data structure of the second map data (P2L table) so that the second map data can be compressed, as compared to when the plurality of requests is related to random data. In a case in which a plurality of requests are related to sequential data, the timing of flushing the map (e.g., performing a map flush) may be delayed, as compared to when the plurality of requests is related to random data. Further, the controller 130 may spend more available resources on performing data input/output operations corresponding to a plurality of requests related to sequential data. Through this procedure, data input/output performance of the memory system 110 may be improved.

According to an embodiment, the input/output controller 192, the map data controller 196, and the pattern checker 194 shown in FIG. 1 may include individual circuitry designed to perform their own functions or may be implemented in a single chip or combined circuitry.

FIGS. 2 and 3 illustrate some operations that may be performed by the memory system 110 according to one or more embodiments.

Referring to FIG. 2, a data processing system 100 may include a host 102 engaged or interlocked with a memory system, such as memory system 110. The host 102 may include a portable electronic device (e.g., a mobile phone, an MP3 player, a laptop computer, etc.) or a non-portable electronic device (e.g., a desktop computer, a game player, a television, a projector, etc.).

The host 102 may also include at least one operating system (OS), which can control functions and operations performed in the host 102. The OS can provide interoperability between the host 102 engaged operatively with the memory system 110 and the user who intends to store data in the memory system 110. The OS may support functions and operations corresponding to user requests. By the way of example but not limitation, the OS can be classified into a general operating system and a mobile operating system according to mobility of the host 102. The general operating system may be split into a personal operating system and an enterprise operating system according to system requirements or a user environment. As compared with the personal operating system, the enterprise operating systems can be specialized for securing and supporting high performance computing.

The mobile operating system may be subject to support services or functions for mobility (e.g., a power saving function). The host 102 may include a plurality of operating systems. The host 102 may execute multiple operating systems interlocked with the memory system 110, corresponding to a user request. The host 102 may transmit a plurality of commands corresponding to the user's requests into the memory system 110, thereby performing operations corresponding to commands within the memory system 110.

The controller 130 in the memory system 110 may control the memory device 150 in response to a request or a command input from the host 102. For example, the controller 130 may perform a read operation to provide a piece of data read from the memory device 150 for the host 102 and may perform a write operation (or a program operation) to store a piece of data input from the host 102 in the memory device 150. In order to perform data input/output (I/O) operations, the controller 130 may control and manage internal operations for data read, data program, data erase, or the like.

According to an embodiment, the controller 130 can include a host interface 132, a processor 134, error correction circuitry 138, a power management unit (PMU) 140, a memory interface 142, and a memory 144. Components included in the controller 130 as illustrated in FIG. 2 may vary according structure, function, operation performance, or the like, regarding the memory system 110 among embodiments. For example, the memory system 110 may be implemented with any of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, an universal serial bus (USB) storage device, an universal flash storage (UFS) device, a compact flash (CF) card, a smart media (SM) card, a memory stick, and the like. Components in the controller 130 may be added or omitted based at implementation of the memory system 110.

The host 102 and the memory system 110 may include a controller or an interface for transmitting and receiving signals, a piece of data, and the like, in accordance with one or more predetermined protocols. For example, the host interface 132 in the memory system 110 may include an apparatus capable of transmitting signals, a piece of data, and the like, to the host 102 or receiving signals, a piece of data, and the like, input from the host 102.

The host interface 132 included in the controller 130 may receive signals, commands (or requests), and/or a piece of data input from the host 102. For example, the host 102 and the memory system 110 may use a predetermined protocol to transmit and receive a piece of data between each other. Examples of protocols or interfaces supported by the host 102 and the memory system 110 for sending and receiving a piece of data include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIE), Serial-attached SCSI (SAS), Serial Advanced Technology Attachment (SATA), Mobile Industry Processor Interface (MIPI), and the like. According to an embodiment, the host interface 132 is a kind of layer for exchanging a piece of data with the host 102 and is implemented with, or driven by, firmware called a host interface layer (HIL).

The Integrated Drive Electronics (IDE) or Advanced Technology Attachment (ATA) may be used as one of the interfaces for transmitting and receiving a piece of data and, for example, may use a cable including 40 wires connected in parallel to support data transmission and reception between the host 102 and the memory system 110. When a plurality of memory systems 110 are connected to a single host 102, the plurality of memory systems 110 may be divided into a master and a slave by using a position or a dip switch to which the plurality of memory systems 110 are connected. The memory system 110 set as the master may be used as the main memory device. The IDE (ATA) may include, for example, Fast-ATA, ATAPI, and Enhanced IDE (EIDE).

Serial Advanced Technology Attachment (SATA) is a kind of serial data communication interface that is compatible with various ATA standards of parallel data communication interfaces which is used by Integrated Drive Electronics (IDE) devices. The 40 wires in the IDE interface can be reduced to six wires in the SATA interface. For example, 40 parallel signals for the IDE can be converted into 6 serial signals for SATA to be transmitted between each other. The SATA has been widely used because of its faster data transmission and reception rate and its less resource consumption in the host 102 used for data transmission and reception. SATA may support connection with up to 30 external devices to a single transceiver included in the host 102. In addition, SATA can support hot plugging that allows an external device to be attached or detached from the host 102, even while data communication between the host 102 and another device is being executed. Thus, the memory system 110 can be connected or disconnected as an additional device, like a device supported by an universal serial bus (USB) even when the host 102 is powered on. For example, in the host 102 having an eSATA port, the memory system 110 may be freely detached like an external hard disk.

Small Computer System Interface (SCSI) is a kind of serial data communication interface used for connection between a computer, a server, and/or other peripheral devices. The SCSI can provide a high transmission speed, as compared with other interfaces such as IDE and SATA. In SCSI, the host 102 and at least one peripheral device (e.g., memory system 110) are connected in series, but data transmission and reception between the host 102 and each peripheral device may be performed through a parallel data communication. In SCSI, it is easy to connect to, or disconnect from, the host 102 a device such as the memory system 110. SCSI can support connections of 15 other devices to a single transceiver included in host 102.

Serial Attached SCSI (SAS) can be understood as a serial data communication version of the SCSI. In SAS, not only the host 102 and a plurality of peripheral devices are connected in series, but also data transmission and reception between the host 102 and each peripheral device may be performed in a serial data communication scheme. SAS can support connection between the host 102 and the peripheral device through a serial cable instead of a parallel cable, to easily manage equipment using SAS and enhance or improve operational reliability and communication performance. SAS may support connections of eight external devices to a single transceiver included in the host 102.

The Non-volatile memory express (NVMe) is a kind of interface based at least on a Peripheral Component Interconnect Express (PCIe) designed to increase performance and design flexibility of the host 102, servers, computing devices, and the like equipped with the non-volatile memory system 110. PCIe can use a slot or a specific cable for connecting the host 102 (e.g., a computing device) and the memory system 110 (e.g., a peripheral device). For example, PCIe can use a plurality of pins (for example, 18 pins, 32 pins, 49 pins, 82 pins, etc.) and at least one wire (e.g. ×1, ×4, ×8, ×16, etc.) to achieve high speed data communication over several hundred MB per second (e.g. 250 MB/s, 500 MB/s, 984.6250 MB/s, 1969 MB/s, and etc.). According to an embodiment, the PCIe scheme may achieve bandwidths of tens to hundreds of Giga bits per second. A system using the NVMe can make the most of an operation speed of the non-volatile memory system 110, such as an SSD, which operates at a higher speed than a hard disk.

According to an embodiment, the host 102 and the memory system 110 may be connected through an universal serial bus (USB). The Universal Serial Bus (USB) is a kind of scalable, hot-pluggable plug-and-play serial interface that can provide cost-effective standard connectivity between the host 102 and a peripheral device, such as a keyboard, a mouse, a joystick, a printer, a scanner, a storage device, a modem, a video camera, and the like. A plurality of peripheral devices such as the memory system 110 may be coupled to a single transceiver included in the host 102.

Referring to FIG. 2, the error correction circuitry 138 can correct error bits of the data to be processed in (e.g., output from) the memory device 150, which may include an error correction code (ECC) encoder and an ECC decoder. The ECC encoder can perform error correction encoding of data to be programmed in the memory device 150 to generate encoded data into which a parity bit is added and store the encoded data in memory device 150. The ECC decoder can detect and correct errors contained in data read from the memory device 150 when the controller 130 reads the data stored in the memory device 150. For example, after performing error correction decoding on the data read from the memory device 150, the error correction circuitry 138 can determine whether the error correction decoding has succeeded and output an instruction signal (e.g., a correction success signal or a correction fail signal). The error correction circuitry 138 can use a parity bit generated during the ECC encoding process for correcting the error bit of the read data. When the number of the error bits is greater than or equal to a threshold number of correctable error bits, the error correction circuitry 138 might not correct error bits but instead may output an error correction fail signal indicating failure in correcting the error bits.

According to an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The error correction circuitry 138 may include all circuits, modules, systems, and/or devices for performing the error correction operation based on at least one of the above described codes.

For example, the ECC decoder may perform hard decision decoding or soft decision decoding to data transmitted from the memory device 150. The hard decision decoding can be understood as one of two methods broadly classified for error correction. Hard decision decoding may include an operation of correcting an error by reading digital data of ‘0’ or ‘1’ from a non-volatile memory cell in the memory device 150. Because the hard decision decoding handles a binary logic signal, the circuit/algorithm design or configuration may be simpler and processing speed may be faster than soft decision decoding.

Soft decision decoding may quantize a threshold voltage of a non-volatile memory cell in the memory device 150 by two or more quantized values (e.g., multiple bit data, approximate values, an analog value, and the like) in order to correct an error based on the two or more quantized values. The controller 130 can receive two or more alphabets or quantized values from a plurality of non-volatile memory cells in the memory device 150, and then perform a decoding based on information generated by characterizing the quantized values as a combination of information such as conditional probability or likelihood.

According to an embodiment, the ECC decoder may use low-density parity-check and generator matrix (LDPC-GM) code among methods designed for the soft decision decoding. The low-density parity-check (LDPC) code uses an algorithm that can read values of data from the memory device 150 in several bits according to reliability, not simply data of 1 or 0 like hard decision decoding, and iteratively repeats it through a message exchange in order to improve reliability of the values. Then, the values are finally determined as data of 1 or 0. For example, a decoding algorithm using LDPC codes can be understood as probabilistic decoding. Hard decision decoding in which the value output from a non-volatile memory cell is coded as 0 or 1. Compared to hard decision decoding, soft decision decoding can determine the value stored in the non-volatile memory cell based on the stochastic information. Regarding bit-flipping (which may be considered an error that can occur in the memory device 150), soft decision decoding may provide improved probability of correcting error and recovering data, as well as provide reliability and stability of corrected data. The LDPC-GM code may have a scheme in which internal LDGM codes can be concatenated in series with high-speed LDPC codes.

According to an embodiment, the ECC decoder may use, for example, low-density parity-check convolutional codes (LDPC-CCs) code for soft decision decoding. The LDPC-CCs code may have a scheme using a linear time encoding and a pipeline decoding based on a variable block length and a shift register.

According to an embodiment, the ECC decoder may use, for example, a Log Likelihood Ratio Turbo Code (LLR-TC) for soft decision decoding. The Log Likelihood Ratio (LLR) may be calculated as a non-linear function for a distance between a sampled value and an ideal value. In addition, Turbo Code (TC) may include a simple code (for example, a Hamming code) in two or three dimensions and repeat decoding in a row direction and a column direction to improve reliability of values.

The power management unit (PMU) 140 may control electrical power provided in the controller 130. The PMU 140 may monitor the electrical power supplied to the memory system 110 (e.g., a voltage supplied to the controller 130) and provide the electrical power to components included in the controller 130. The PMU 140 can not only detect power-on or power-off, but also generate a trigger signal to enable the memory system 110 to back up a current state urgently when the electrical power supplied to the memory system 110 is unstable. According to an embodiment, the PMU 140 may include a device or a component capable of accumulating electrical power that may be used in an emergency.

The memory interface 142 may serve as an interface for handling commands and data transferred between the controller 130 and the memory device 150, in order to allow the controller 130 to control the memory device 150 in response to a command or a request input from the host 102. The memory interface 142 may generate a control signal for the memory device 150 and may process data input to, or output from, the memory device 150 under the control of the processor 134 in a case when the memory device 150 is a flash memory. For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) for exchanging data with the memory device 150.

According to an embodiment, the memory interface 142 may support an open NAND flash interface (ONFi), a toggle mode, or the like, for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), and a toggle double data rate (DDR).

The memory 144 may be a type of working memory in the memory system 110 or the controller 130, while storing temporary or transactional data occurred or delivered for operations in the memory system 110 and the controller 130. For example, the memory 144 may temporarily store read data output from the memory device 150 in response to a request from the host 102, before the read data is output to the host 102. In addition, the controller 130 may temporarily store write data input from the host 102 in the memory 144, before programming the write data in the memory device 150. When the controller 130 controls operations such as data read, data write, data program, data erase, etc., of the memory device 150, a piece of data transmitted or generated between the controller 130 and the memory device 150 of the memory system 110 may be stored in the memory 144.

In addition to the read data or write data, the memory 144 may store information (e.g., map data, read requests, program requests, etc.) used for inputting or outputting data between the host 102 and the memory device 150. According to an embodiment, the memory 144 may include a command queue, a program memory, a data memory, a write buffer/cache, a read buffer/cache, a data buffer/cache, a map buffer/cache, and/or the like. The controller 130 may allocate some storage space in the memory 144 for a component which is established to carry out a data input/output operation. For example, the write buffer established in the memory 144 may be used to temporarily store target data subject to a program operation.

In an embodiment, the memory 144 may be implemented with a volatile memory. For example, the memory 144 may be implemented with a static random access memory (SRAM), a dynamic random access memory (DRAM), or both. Although FIG. 2 illustrates, for example, the memory 144 disposed within the controller 130, the embodiments are not limited thereto. The memory 144 may be located within or external to the controller 130. For instance, the memory 144 may be embodied by an external volatile memory having a memory interface transferring data and/or signals between the memory 144 and the controller 130.

The processor 134 may control the overall operations of the memory system 110. For example, the processor 134 can control a program operation or a read operation of the memory device 150, in response to a write request or a read request entered from the host 102. According to an embodiment, the processor 134 may execute firmware to control the program operation or the read operation in the memory system 110. Herein, the firmware may be referred to as a flash translation layer (FTL). An example of the FTL is later described in detail, referring to FIG. 3. According to an embodiment, the processor 134 may be implemented with a microprocessor or a central processing unit (CPU).

According to an embodiment, the memory system 110 may be implemented with at least one multi-core processor. The multi-core processor is a kind of circuit or chip in which two or more cores, which are considered distinct processing regions, are integrated. For example, when a plurality of cores in the multi-core processor drive or execute a plurality of flash translation layers (FTLs) independently, data input/output speed (or performance) of the memory system 110 may be improved. According to an embodiment, the data input/output (I/O) operations in the memory system 110 may be independently performed through different cores in the multi-core processor.

The processor 134 in the controller 130 may perform an operation corresponding to a request or a command input from the host 102. Further, the memory system 110 may be independent of a command or a request input from an external device such as the host 102. In one case, an operation performed by the controller 130 in response to the request or the command input from the host 102 may be considered a foreground operation, while an operation performed by the controller 130 independently (e.g., regardless the request or the command input from the host 102) may be considered a background operation. The controller 130 can perform foreground or background operations for read, write or program, erase and the like, regarding a piece of data in the memory device 150. In addition, a parameter set operation corresponding to a set parameter command or a set feature command as a set command transmitted from the host 102 may be considered a foreground operation. Meanwhile, as a background operation without a command transmitted from the host 102, the controller 130 can perform garbage collection (GC), wear leveling (WL), bad block management for identifying and processing bad blocks, or the like may be performed in relation to a plurality of memory blocks 152, 154, 156 included in the memory device 150.

According an embodiment, substantially similar operations may be performed as both the foreground operation and the background operation. For example, when the memory system 110 performs garbage collection in response to a request or a command input from the host 102 (e.g., Manual GC), garbage collection can be considered a foreground operation. When the memory system 110 performs garbage collection independently of the host 102 (e.g., Auto GC), garbage collection can be considered a background operation.

When the memory device 150 includes a plurality of dies (or a plurality of chips) including non-volatile memory cells, the controller 130 may be configured to perform a parallel processing regarding plural requests or commands input from the host 102 in to improve performance of the memory system 110. For example, the transmitted requests or commands may be divided and processed simultaneously into a plurality of dies or a plurality of chips in the memory device 150. The memory interface 142 in the controller 130 may be connected to a plurality of dies or chips in the memory device 150 through at least one channel and at least one way. When the controller 130 distributes and stores data in the plurality of dies through each channel or each way in response to requests or a commands associated with a plurality of pages including non-volatile memory cells, plural operations corresponding to the requests or the commands can be performed simultaneously or in parallel. Such a processing method or scheme can be considered as an interleaving method. Because data input/output speed of the memory system 110 operating with the interleaving method may be faster than that without the interleaving method, data I/O performance of the memory system 110 can be improved.

By the way of example but not limitation, the controller 130 can recognize statuses regarding a plurality of channels (or ways) associated with a plurality of memory dies included in the memory device 150. The controller 130 may determine the status of each channel or each way as one of, for example, a busy status, a ready status, an active status, an idle status, a normal status, and/or an abnormal status. The determination of which channel or way an instruction (and/or a data) is delivered through by the controller can be associated with a physical block address, e.g., which die(s) the instruction (and/or the data) is delivered into. The controller 130 can refer to descriptors delivered from the memory device 150. The descriptors can include a block or page of parameters that describe something about the memory device 150, which is data with a set format or structure. For instance, the descriptors may include device descriptors, configuration descriptors, unit descriptors, and the like. The controller 130 can refer to, or use, the descriptors to determine which channel(s) or way(s) an instruction or a data is exchanged via.

Referring to FIG. 2, the memory device 150 in the memory system 110 may include the plurality of memory blocks 152, 154, 156. Each of the plurality of memory blocks 152, 154, 156 includes a plurality of non-volatile memory cells. According to an embodiment, the memory block 152, 154, 156 can be a group of non-volatile memory cells erased together. The memory block 152, 154, 156 may include a plurality of pages which is a group of non-volatile memory cells read or programmed together. In one embodiment, each memory block 152, 154, 156 may have a three-dimensional stack structure for a high integration. Further, the memory device 150 may include a plurality of dies, each die including a plurality of planes, each plane including the plurality of memory blocks 152, 154, 156. Configuration of the memory device 150 can be different for performance of the memory system 110.

In the memory device 150 shown in FIG. 2, the plurality of memory blocks 152, 154, 156 are included. The plurality of memory blocks 152, 154, 156 can be any of single-level cell (SLC) memory blocks, multi-level cell (MLC) Cell) memory blocks, or the like, according to the number of bits that can be stored or represented in one memory cell. An SLC memory block includes a plurality of pages implemented by memory cells, each storing one bit of data. An SLC memory block can have high data I/O operation performance and high durability. The MLC memory block includes a plurality of pages implemented by memory cells, each storing multi-bit data (e.g., two bits or more). The MLC memory block can have larger storage capacity for the same space compared to the SLC memory block. The MLC memory block can be highly integrated in a view of storage capacity.

In an embodiment, the memory device 150 may be implemented with MLC memory blocks such as a double level cell (DLC) memory block, a triple-level cell (TLC) memory block, a quadruple-level cell (QLC) memory block and a combination thereof. The double-level cell (DLC) memory block may include a plurality of pages implemented by memory cells, each capable of storing 2-bit data. The triple-level cell (TLC) memory block can include a plurality of pages implemented by memory cells, each capable of storing 3-bit data. The quadruple-level cell (QLC) memory block can include a plurality of pages implemented by memory cells, each capable of storing 4-bit data. In another embodiment, the memory device 150 can be implemented with a block including a plurality of pages implemented by memory cells, each capable of storing five or more bits of data.

According to an embodiment, the controller 130 may use a multi-level cell (MLC) memory block included in the memory system 150 as an SLC memory block that stores one-bit data in one memory cell. A data input/output speed of the multi-level cell (MLC) memory block can be slower than that of the SLC memory block. That is, when the MLC memory block is used as the SLC memory block, a margin for a read or program operation can be reduced. The controller 130 can utilize a faster data input/output speed of the multi-level cell (MLC) memory block when using the multi-level cell (MLC) memory block as the SLC memory block. For example, the controller 130 can use the MLC memory block as a buffer to temporarily store a piece of data, because the buffer may require a high data input/output speed for improving performance of the memory system 110.

Further, according to an embodiment, the controller 130 may program pieces of data in a multi-level cell (MLC) a plurality of times without performing an erase operation on a specific MLC memory block included in the memory system 150. Non-volatile memory cells have a feature that does not support data overwrite. However, the controller 130 may use a feature in which a multi-level cell (MLC) may store multi-bit data, in order to program plural pieces of 1-bit data in the MLC a plurality of times. For MLC overwrite operation, the controller 130 may store the number of program times as separate operation information when a single piece of 1-bit data is programmed in a non-volatile memory cell. According to an embodiment, an operation for uniformly levelling threshold voltages of non-volatile memory cells can be carried out before another piece of data is overwritten in the same non-volatile memory cells.

In an embodiment, the memory device 150 is embodied as a non-volatile memory such as a flash memory, for example, as a NAND flash memory, a NOR flash memory, and the like. In one embodiment, the memory device 150 may be implemented by at least one of a phase change random access memory (PCRAM), a ferroelectrics random access memory (FRAM), a spin injection magnetic memory (SU-RAM), and a spin transfer torque magnetic random access memory (STT-MRAM), or the like.

Referring to FIG. 3, a controller 130 in a memory system operates along with the host 102 and the memory device 150. As illustrated, the controller 130 includes a host interface 132, a flash translation layer (FTL) 240, as well as the memory interface 142, and the memory 144 previously identified in connection with FIG. 2.

According to an embodiment, the error correction circuitry 138 illustrated in FIG. 2 may be included in the flash translation layer (FTL) 240. In another embodiment, the error correction circuitry 138 may be implemented as a separate module, a circuit, firmware, or the like, which is included in, or associated with, the controller 130.

The host interface 132 may be capable of handling commands, data, and the like transmitted from the host 102. By way of example but not limitation, the host interface 132 may include a command queue 56, a buffer manager 52, and an event queue 54. The command queue 56 may sequentially store commands, data, and the like, received from the host 102 and output them to the buffer manager 52, for example, in an order in which they are stored. The buffer manager 52 may classify, manage, or adjust the commands, the data, and the like, which are received from the command queue 56. The event queue 54 may sequentially transmit events for processing the commands, the data, and the like, received from the buffer manager 52.

A plurality of commands or data of the same characteristic (e.g., read or write commands) may be transmitted from the host 102, or plurality of commands and data of different characteristics may be transmitted to the memory system 110 after being mixed or jumbled by the host 102. For example, a plurality of commands for reading data (read commands) may be delivered, or commands for reading data (read command) and programming/writing data (write command) may be alternately transmitted to the memory system 110. The host interface 132 may store commands, data, and the like, which are transmitted from the host 102, to the command queue 56 sequentially. Thereafter, the host interface 132 may estimate or predict what kind of internal operation the controller 130 will perform according to the characteristics of commands, data, and the like, which have been entered from the host 102. The host interface 132 can determine a processing order and a priority of commands, data and the like, based at least on their characteristics.

According to characteristics of commands, data, and the like transmitted from the host 102, the buffer manager 52 in the host interface 132 is configured to determine whether the buffer manager should store commands, data, and the like, in the memory 144, or whether the buffer manager should deliver the commands, the data, and the like into the flash translation layer (FTL) 240. The event queue 54 receives events, entered from the buffer manager 52, which are to be internally executed and processed by the memory system 110 or the controller 130 in response to the commands, the data, and the like, transmitted from the host 102, in order to deliver the events into the flash translation layer (FTL) 240 in the order received.

In accordance with an embodiment, the flash translation layer

(FTL) 240 illustrated in FIG. 3 may implement a multi-thread scheme to perform the data input/output (I/O) operations. A multi-thread FTL may be implemented through a multi-core processor using multi-thread included in the controller 130.

In accordance with an embodiment, the flash translation layer (FTL) 240 can include a host request manager (HRM) 46, a map manager (MM) 44, a state manager 42, and a block manager 48. The host request manager (HRM) 46 can manage the events entered from the event queue 54. The map manager (MM) 44 can handle or control a map data. The state manager 42 can perform garbage collection (GC) or wear leveling (WL). The block manager 48 can execute commands or instructions onto a block in the memory device 150.

By way of example but not limitation, the host request manager (HRM) 46 can use the map manager (MM) 44 and the block manager 48 to handle or process requests according to the read and program commands, and events which are delivered from the host interface 132. The host request manager (HRM) 46 can send an inquiry request to the map data manager (MM) 44, to determine a physical address corresponding to the logical address which is entered with the events. The host request manager (HRM) 46 can send a read request with the physical address to the memory interface 142, to process the read request (handle the events). In one embodiment, the host request manager (HRM) 46 can send a program request (write request) to the block manager 48 to program data to a specific empty page (no data) in the memory device 150, and then can transmit a map update request corresponding to the program request to the map manager (MM) 44, in order to update an item relevant to the programmed data in information of mapping the logical-physical addresses to each other.

The block manager 48 can convert a program request delivered from the host request manager (HRM) 46, the map data manager (MM) 44, and/or the state manager 42 into a flash program request used for the memory device 150, in order to manage flash blocks in the memory device 150. In order to maximize or enhance program or write performance of the memory system 110 (e.g., see FIG. 2), the block manager 48 may collect program requests and send flash program requests for multiple-plane and one-shot program operations to the memory interface 142. In an embodiment, the block manager 48 sends several flash program requests to the memory interface 142 to enhance or maximize parallel processing of the multi-channel and multi-directional flash controller.

In one embodiment, the block manager 48 can be configured to manage blocks in the memory device 150 according to the number of valid pages, select and erase blocks having no valid pages when a free block is needed, and select a block including the least number of valid pages when it is determined that garbage collection is to be performed. The state manager 42 can perform garbage collection to move the valid data to an empty block and erase the blocks containing the moved valid data so that the block manager 48 may have enough free blocks (empty blocks with no data). When the block manager 48 provides information regarding a block to be erased to the state manager 42, the state manager 42 may check all flash pages of the block to be erased to determine whether each page is valid.

For example, to determine validity of each page, the state manager 42 can identify a logical address recorded in an out-of-band (OOB) area of each page. To determine whether each page is valid, the state manager 42 can compare the physical address of the page with the physical address mapped to the logical address obtained from the inquiry request. The state manager 42 sends a program request to the block manager 48 for each valid page. A mapping table can be updated through the update of the map manager 44 when the program operation is complete.

The map manager 44 can manage a logical-physical mapping table. The map manager 44 can process various requests, for example, queries, updates, and the like, which are generated by the host request manager (HRM) 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks in the map manager 44 exceeds a certain threshold, a program request can be sent to the block manager 48 so that a clean cache block is made and the dirty map table may be stored in the memory device 150.

When garbage collection is performed, the state manager 42 copies valid page(s) into a free block, and the host request manager (HRM) 46 can program the latest version of the data for the same logical address of the page and currently issue an update request. When the status manager 42 requests the map update in a state in which copying of valid page(s) is not completed normally, the map manager 44 might not perform the mapping table update. This is because the map request is issued with old physical information when the status manger 42 requests a map update and a valid page copy is completed later. The map manager 44 may perform a map update operation to ensure accuracy when, or only if, the latest map table still points to the old physical address.

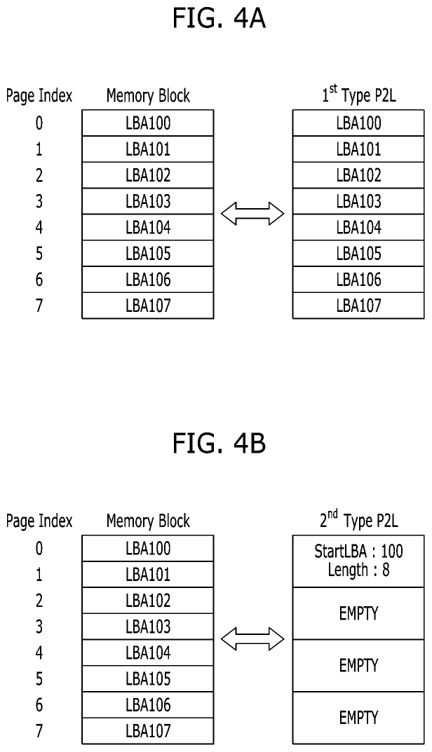

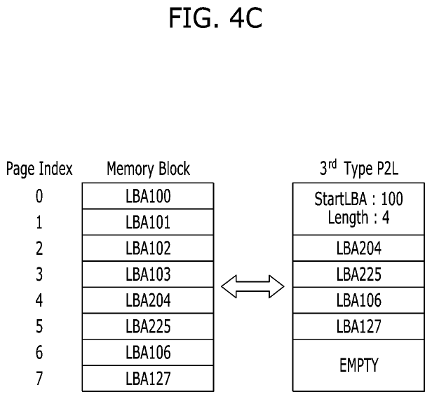

FIGS. 4A to 4C illustrate examples of data structures of map data according to various embodiments. Specifically, FIGS. 4A to 4C shows data structures which the second map data (P2L table) can have depending upon a pattern regarding operations corresponding to a plurality of requests.

Referring to FIG. 4A, a plurality of memory blocks may be included in the memory device 150 (e.g., see FIGS. 1 to 3) included in the memory system 110 (e.g., see FIGS. 1 to 3). The memory block illustrated in FIG. 4A may include 8 pages as an example, and the 8 pages may be identified through page indexes (0-7). According to an embodiment, when combining a block address for distinguishing a plurality of memory blocks from each other and a page index, the memory device 150 may use combined one as a physical address indicating a location where data in the memory device 150 is stored.

Plural pieces of data corresponding to the logical addresses LBA100 to LBA107 may be sequentially stored in the eight pages (page indexes 0 to 7 respectively) of a memory block through the write operation in the memory system 110. After programming the plural pieces of data corresponding to the logical addresses LBA100 to LBA107 into the memory block, the controller 130 (e.g., see FIGS. 1 to 3) may add plural pieces of map information into the second map data (P2L table) in the memory 144 (e.g., see FIGS. 1 to 3).

The second map data (1st Type P2L table), having a first data structure illustrated in FIG. 4A, may include logical addresses LBA100 to LBA107 corresponding to plural pieces of data stored in the memory block. A first piece of the second map data (1st Type P2L table) having the first data structure can show that a piece of data corresponding to a first logical address LBA100 is stored in a location indicated by a first page (Page Index 0) of the corresponding memory block in the memory device 150. The logical address LBA100 associated with the data stored in the first page (Page Index 0) of the memory block may be stored as the first piece of the second map data (1st Type P2L table). Because plural pieces of pieces of data corresponding to 8 logical addresses (LBA100 to LBA107) is sequentially stored in 8 pages (page indexes 0 to 7 respectively) of the memory block, the second map data (1st Type P2L table) having the first data structure can include the 8 logical addresses (LBA100 to LBA107). That is, eight logical addresses (LBA100 to LBA107) may be sequentially stored in the pieces of the second map data (1st Type P2L table).

The second map data (P2L table) having the first data structure (1st Type) shown in FIG. 4A may adopt a way of adding a single logical address in a single piece of map information. For example, when the second map data has the first data structure (1st Type P2L table) and the controller 130 stores 50 pieces of data in the memory device 150, and 50 logical addresses are added into the second map data (1st Type P2L table) in the memory 144. The second map data (1st Type P2L table) may have at least 50 pieces (e.g., 50 pieces of map information). When a space allocated for the second map data (1st Type P2L table) in the memory 144 is not sufficient to include 50 pieces (e.g., to store 50 logical addresses), the controller 130 removes one or more pieces of map information in the second map data (1st Type P2L table) before storing the 50 pieces of data in the memory device 150. When the space corresponding to the second map data (1st Type P2L table) is filled with a piece of second map information before the 50 pieces of data are programmed, the controller 130 may perform an operation for updating first map data in the memory device 150 based on the piece of second map information. This operation can be referred to as a map flush. While a map flush is performed, the operation for programming some of the 50 pieces of data in the memory device 150 may be delayed.

Because the second map data having the first data structure (1st Type P2L table) shown in FIG. 4A includes a single logical address in a single piece of map information, the controller 130 may utilize the first data structure for data input and output operations regarding random data, not sequential data. For example, in a process of performing program operations corresponding to plural requests regarding the random data the operation, the controller 130 may determine that the second map data has the first data structure (1st Type P2L table). For example, when it is determined by the pattern checker 194 described in FIG. 1 that the data input/output operations are related to random data, the map data controller 196 may generate the second map data having the first data structure (1st Type P2L table) in the memory 144.

Referring to FIG. 4B, the second map data (P2L table) having a second data structure (2nd Type) may store a start address and a continuous count (Length) regarding plural logical addresses in a single piece of map information. The controller 130 may generate and use the second map data having the second data structure (2nd Type P2L table) to perform data input/output operations regarding sequential data. The start address of the plural logical addresses may correspond to a start piece of data in the sequential data, and the continuous count of the plural logical addresses can correspond to how many pieces of data are included in the sequential data. In FIG. 4B, eight pieces of data corresponding to eight logical addresses LBA100 to LBA107 are sequentially stored in eight pages (page indexes 0 to 7) of the memory block, similar to FIG. 4A. When the eight pieces of data are sequentially stored in the memory block, the first logical address (LBA100) among the eight logical addresses (LBA100 to LBA107) is added in a first item of the second map data having the second data structure (2nd Type P2L table) as the start address of the plural logical addresses, and eight (Length: 8) is added in the first item as the continuous count regarding the eight logical addresses (LBA100 to LBA107).

Referring to two cases shown in FIGS. 4A and 4B, when data corresponding to eight logical addresses LBA100 to LBA107 is stored in eight pages (page indexes 0 to 7) of a memory block, the second map data having the first data structure (1st Type P2L table) can be fully filled with eight pieces of map information, but the second map data might not be fully filled with the eight pieces of map information when the second map data has the second data structure (2nd Type P2L table). When the second map data having the second data structure (2nd Type P2L table) is not fully filled, the controller 130 can perform another program operation to program another piece of data in the memory device 150 before performing a map flush. When the controller 130 slows down a timing of flushing plural pieces of map information to the memory device 150 and performs additional program operations regarding other pieces of data, data input/output performance of the memory system 110 may be improved.

According to an embodiment, a space allocated for the second map data (P2L table) may be fixed. According to a data structure of the second map data (P2L table) generated by the controller 130, differences may occur at the time of filling the second map data (P2L table) with pieces of map information, with each piece of map information generated by the data input/output operation (e.g., a program operation). If the timing of when the second map data (P2L table) is filled with pieces of map information is different, the timing at which a map flush is performed may be changed.

According to an embodiment, the space allocated for the second map data (P2L table) may not be fixed. Depending on the data structure of the second map data (P2L table) generated by the controller 130, the size of the space for the second map data (P2L table) may be changed. The storage capability of the memory 144 is finite. Thus, when the space required for the second map data (P2L table) is reduced, the controller 130 may allocate and distribute an available space for another operation and purpose. Through this procedure, when more available resources are allocated or distributed for data input/output operations, the controller 130 may improve data input/output performance of the memory system 110.

Referring to FIG. 4C, the second map data (P2L table) may have a third data structure (3rd Type P2L table) which includes a combination of the first data structure and the second data structure. The controller 130 may generate and use the second map data having the third data structure (3rd Type P2L table) in a process of performing data input/output operations regarding mixed data of random data and sequential data. For example, when plural requests input from the external device such as the host 102 to the memory system 110 are related to the mixed random data and sequential data, the controller 130 may generate the second map data having the third data structure (3rd Type P2L table).

According to an embodiment, when plural requests input from the host 102 to the memory system 110 are related to mixed random data and sequential data, the controller 130 may select one of the data structures, and then change the data structure of the second map data (P2L table) based on the pattern. When the controller 130 changes the data structure of the second map data (P2L table) in the memory 144, map information included in the second map data (P2L table) may be flushed in the memory device 150 before the data structure of the second map data (P2L table) is changed. In this case, even when the second map data (P2L table) is not fully filled with map information, the controller 130 may perform the map flush before the data structure of the second map data (P2L table) is changed.

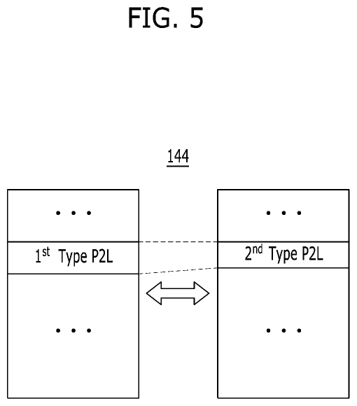

FIG. 5 illustrates an example of a space change allocated for map data in a volatile memory according to an embodiment. Referring to FIG. 5, the controller 130 (e.g., see FIGS. 1 to 3) may allocate a space for the second map data (P2L table) to the memory 144 in the memory system 110 (e.g., see FIGS. 1 to 3). Corresponding to various data structures of the second map data (P2L table) described with reference to FIGS. 4A to 4C, the size of the space allocated for the second map data (P2L table) in the memory 144 may be different.

For example, when the memory system 110 performs data input/output operations for sequential data, as illustrated in FIG. 5, the size of the space allocated for the second map data having the second data structure (2nd Type P2L table) may be smaller than that having the first data structure (1st Type P2L table).

When the memory system 110 performs data input/output operations regarding random data, the size of the space occupied by the second map data (P2L table) having the first data structure (1st Type) may be smaller than that of the second data structure (2nd Type).

Accordingly, when the controller 130 generates the second map data (P2L table) having different types of data structures in response to the pattern regarding data input/output operations, the space in the memory 144 can be used more efficiently. In addition, when the controller 130 allocates an available space for another operation as the space for the second map data (P2L table) in the memory 144 is reduced, operation performance of the memory system 110 can be improved.

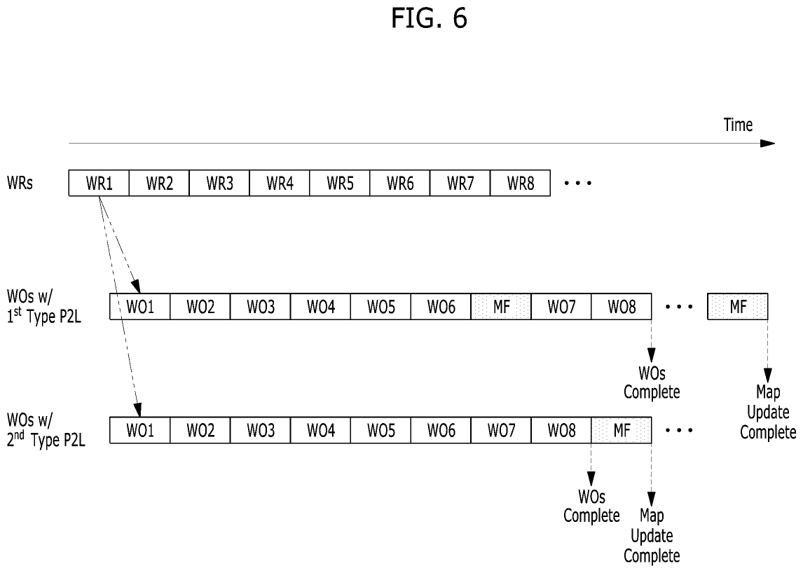

FIG. 6 illustrates data input/output operations performed by a memory system according to an embodiment. Referring to FIG. 6, the memory system 110 (e.g., see FIGS. 1 to 3) receives a plurality of write requests WRs input from an external device. For example, the plurality of write requests WRs may include eight write requests WR1 to WR8. The memory system 110 may receive the eight write requests WR1 to WR8 together with eight pieces of data corresponding to eight logical addresses. In an embodiment, the eight write requests WR1 to WR8 may be related to sequential data. The memory system 110 may perform eight write operations WO1 to WO8 corresponding to the eight write requests WR1 to WR8.

According to an embodiment, the memory system 110 may determine a data structure of the second map data (P2L table) after determining a pattern regarding write requests WRs which have been input before the first write request WR1 is input. In FIG. 6, when the controller 130 generates the second map data having a first data structure (1st Type P2L table), the controller 130 may perform eight write operations WO1 to WO8 (WOs w/1st Type P2L table shown in FIG. 6). When the controller 130 generates the second map data having a second data structure (2nd Type P2L table), the controller 130 may perform eight write operation WO1 to WO8 (WOs w/2nd Type P2L table shown in FIG. 6). In the embodiment shown in FIG. 6, the second map data (P2L table) may be capable of storing less than eight pieces of a piece of second map information.

In a case of write operations with 1st Type P2L table, when the controller 130 generates the second map data having the first data structure (1st Type P2L table), because the second map data (P2L table) can store less than eight pieces of map information, a map flush MF operation may be performed before completely performing all eight write operations (WO1 to W08) corresponding to the eight write requests (WR1 to WR8). Due to the map flush MF, the seventh write operation WO7 and the eighth write operation WO8 may be delayed. Also, pieces of map information generated by the seventh write operation WO7 and the eighth write operation W08, which are performed after a map flush MF, may be delayed until the next map flush MF is performed.

In the case of write operations with 2nd Type P2L table, when the controller 130 generates the second map data having the second data structure (2nd Type P2L table), the map flush (MF) may be performed after all eight write operations (WO1 to W08) corresponding to the eight write requests (WR1 to WR8) are performed even though the second map data (P2L table) is capable of storing less than eight pieces of a piece of second map information. Referring to FIG. 4B, when a write operation on sequential data is performed, plural pieces of map information in the second map data (P2L table) may be compressed so that the second map data (P2L table) may store more map information. Therefore, the map flush (MF) may occur after all eight write operations WO1 to WO8 are performed. That is, the memory system 110 completes the eight write operations WO1 to WO8 corresponding to the eight write requests WR1 to WR8 input from the external device without the map flush being performed midway among the write operations WO1 to W08. Therefore, sending notification corresponding to the eight write requests WR1 to WR8 can be faster. In addition, because the plurality of pieces of map information corresponding to the eight write operations WO1 to WO8 can be stored in the memory device 150 through the map flush (MF), operation stability of the memory system 110 may be improved in the case of performing write operations with 2nd Type P2L table in which the controller generates the second map data having the second data structure (2nd Type P2L table), as compared to a case of performing write operations with 1st Type P2L table in which the controller 130 generates the second map data having the first data structure (1st Type P2L Table).

FIG. 6 illustrates an example of how operational performance or operational stability of the memory system 110 may be improved depending upon a data structure of the second map data (P2L table).

Referring to FIG. 6, when the memory system 110 receives requests for storing a large amount of data input from an external device, the large amount of data may be sequential data. In this case, as a map flush (MF) is delayed to a greater extent in a process of storing a large amount of data, the external device may recognize that the operational performance of the memory system 110 may be improved to a greater extent.

According to an embodiment, requests input from the external device may include an identifier or a parameter indicating whether the requests are related to random data or sequential data. When the controller 130 receives the identifier or the parameter for a pattern regarding the requests input from the external device, the controller 130 may determine a data structure of the second map data (P2L table) in response to the identifier or the parameter. When the data structure of the second map data (P2L table) is to be changed according to the identifier or the parameter, the controller 130 may store a piece of second map information (P2L) included in the previous second map data (P2L table) in the memory device 150, or update first map data (L2P table) based on the piece of second map information (P2L). After storing the piece of second map information in the memory device 150 or updating the first map data (L2P table), the data structure of the second map data (P2L table) may be changed.

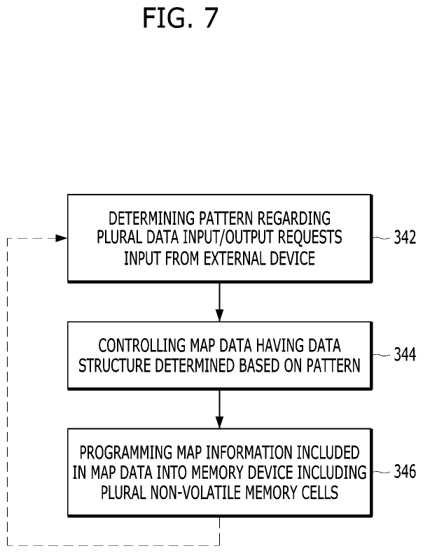

FIG. 7 illustrates an example of a method for operating a memory system according to an embodiment. Referring to FIG. 7, the method for operating a memory system includes determining a pattern regarding a plurality of data input/output requests input from an external device (operation 342), controlling map data having a data structure determined based on the pattern (operation 344), and programming map information included in the map data into a memory device including plural non-volatile memory cells (operation 346). In one embodiment, the external device may be physically separated from the memory system. For example, referring to FIGS. 1 to 3, a host 102 coupled to the memory system 110 through a data path such as a bus may be considered a kind of the external device.

According to an embodiment, in order to determine the pattern regarding plurality of data input/output requests, the memory system may check parameters or identifiers included in the data input/output requests. For example, the data input/output request may include a read request, a write request, an erase request, or another type of request that the host 102 transmits to the memory system 110. A write request input from the host 102 may include a parameter or an identifier indicating whether it is related to sequential data or random data. The memory system 110 may determine the pattern regarding data input/output operations to be subsequently performed through the parameter or the identifier included in the write request.

In another embodiment, the pattern may be determined by tracking or monitoring data input/output operations which have been performed by a memory system for a predetermined period. For example, the memory system may determine whether plural pieces of data input/output operations, performed before a map flush, is related to sequential data or random data. After the memory system performs the write operation, a first count can be increased when the write operation is related to sequential data and a second count can be increased when the write operation is related to random data. When performing a map flush, the memory system may compare the first count with the second count. The memory system may recognize which write operations regarding sequential data or random data are performed to a greater extent between two map flushes. For example, referring to FIG. 1, the pattern checker 194 may increase the first count or the second count as indicated above whenever operations corresponding to a plurality of data input/output requests is performed. Based on the first count and the second count, the memory system can expect, estimate, or determine whether the data input/output operation to be performed is related to sequential data or random data.

According to an embodiment, the memory system may check a logical address delivered with each of plurality of data input/output requests. Based on the logical address delivered with each of the plurality of data input/output requests, the memory system can determine whether the corresponding plurality of data input/output requests are related to sequential data or random data. For example, referring to FIG. 3, the host interface 132 in the controller 130 temporarily stores plural data input/output requests input from the host 102 in the command queue 56. The buffer manager 52 in the controller 130 may determine and classify whether the plural data input/output requests stored in the command queue 56 are related to sequential data or random data.

After the memory system determines a pattern regarding plurality of data input/output requests, the data structure of the map data may be determined in response to the pattern (operation 344). For example, referring to FIGS. 4A to 4C, the map data may include the second map data (P2L table) and the data structure of the second map data (P2L table) may be determined (or selected) as the first data structure, the second data structure, or the third data structure. The data structure of the second map data (P2L table) described with reference to FIGS. 4A to 4C is only an example. Different data structures may be used in other embodiments.

Referring to FIGS. 1 to 3, after determining the data structure of the map data, the memory system may generate map data having the determined data structure in the memory 144 (operation 344). In the map data generated in the memory 144 in the memory system, the memory system may record map information generated or changed according to a data input/output operation.

Map information included in the map data may be stored in a memory device including non-volatile memory cells (operation 346). Referring to FIGS. 1 to 3, the map data stored in the memory device 150 is updated based on the map information in the memory 144, so that the memory system 110 can output the most recent data corresponding to the logical address input along with the data input/output request from the host 102. The operation of storing the map information in the memory device 150 may be considered a map flush for updating the first map data (L2P table) based on the map information (P2L) of the second map data (P2L table).

Depending on the embodiment, the timing of performing a map flush may be different. For example, when map data generated in the memory 144 is fully filled with map information, the memory system may perform a map flush. Depending on the data structure of the map data, the number or range of pieces of map information that can be stored or recorded in the map data may be different. Accordingly, referring to FIGS. 1 to 5, the timing of performing a map flush may be determined based on the data structure of map data. The data structure may be determined (or selected) according to a pattern regarding plurality of data input/output requests.

When a map flush is performed, existing map data may be erased or destroyed and the memory system can generate new map data. To generate new map data, the memory system may determine a pattern regarding a plurality of data input/output requests input from the external device (operation 342).

As another embodiment, when the data structure of map data is changed, a map flush may be performed even though the map data in the memory 144 is not fully filled. According to an embodiment, the memory system may dynamically determine when to generate map data or change the data structure of the map data. For example, even if the map data in the memory 144 is not fully filled with map information, the memory system may detect that a pattern regarding plural data input/output requests input from the external device is changed. For example, after plural pieces of data input/output operations related to random data are performed, a plurality of data input/output requests regarding a large amount of sequential data may be input. In this case, the memory system may generate new map data having a data structure corresponding to a changed pattern, and the map information included in the previous map data may be used to update map data stored in the memory device.

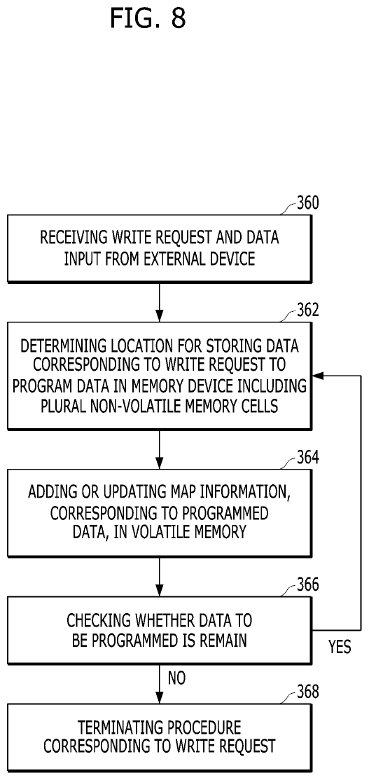

FIG. 8 illustrates another example of a method for operating a memory system according to an embodiment. In this example, the memory system performs an internal operation corresponding to a write request input from an external device.

Referring to FIG. 8, the method for operating the memory system includes receiving a write request and an piece of data input from the external device (operation 360), determining a location for storing the piece of data corresponding to the write request to program the piece of data in a memory device including plural non-volatile memory cells (operation 362), adding or updating a piece of map information corresponding to the programmed piece of data in a volatile memory (operation 364), checking whether another piece of data to be programmed remains (operation 366), and terminating a procedure corresponding to the write request (operation 368).

Referring to FIGS. 1 to 3 and 8, the controller 130 in the memory system 110 may receive a write request and an piece of data input from the host 102, which, for example, is located external to the memory system 110 (operation 360). Depending on an embodiment, the write request may be input from the host 102 with the logical address and the piece of data. According to an embodiment, the write request may include a parameter or an identifier indicating whether it is related to sequential data or random data.

The controller 130 may store the piece of data corresponding to the write request in the memory device 150 (operation 362). For example, the controller 130 may program the piece of data corresponding to the write request to an open memory block in the memory device 150. When there is a plurality of open blocks in the memory device 150, the controller 130 may store the piece of data in all or part of the plurality of open blocks. The controller 130 may determine where to store the piece of data corresponding to the write request based on an operation state of the memory device 150 or a status of data paths (e.g., channels/ways) between the controller 130 and the memory device 150. After determining the location to store the data, the controller 130 transmits the piece of data to a data buffer or a page buffer related to a corresponding location, such as a die, a plane, or a block in the memory device 150. After receiving the piece of data, the memory device 150 may store (program) the piece of data in the memory block and notify the controller 130 that the data is completely programmed.

The controller 130 may add or update map information associating a logical address with a physical address regarding the piece of data, in response to a notification that the piece of data in the memory device 150 has been programmed, in the second map data (P2L table) in the memory 144 (operation 364). According to an embodiment, when second map data (P2L table) is not in the memory 144, the controller 130 may generate new second map data (P2L table) in the memory 144. When the map information cannot be added or updated because there is no available space in the second map data P2L table in the memory 144, the controller 130 may perform a map flush. The operation for generating the second map data (P2L table) or performing the map flush may be shown in FIG. 7.

After adding or updating map information related to the piece of data stored in the memory device 150 to the second map data (P2L table), the controller 130 may check whether another piece of data to be programmed remains (operation 366). When there is an piece of data to be programmed (e.g., YES in operation 366), the controller 130 may determine a location to store the piece of data and program the piece of data in the memory device 150 (operation 362). If there is no data to be programmed (e.g., NO in operation 366), the controller 130 may terminate the internal operation corresponding to the write request (operation 368). After the controller 130 terminates the internal operation corresponding to the write request, the controller 130 may notify the host 102 that the piece of data corresponding to the write request is successfully stored in the memory system 110.

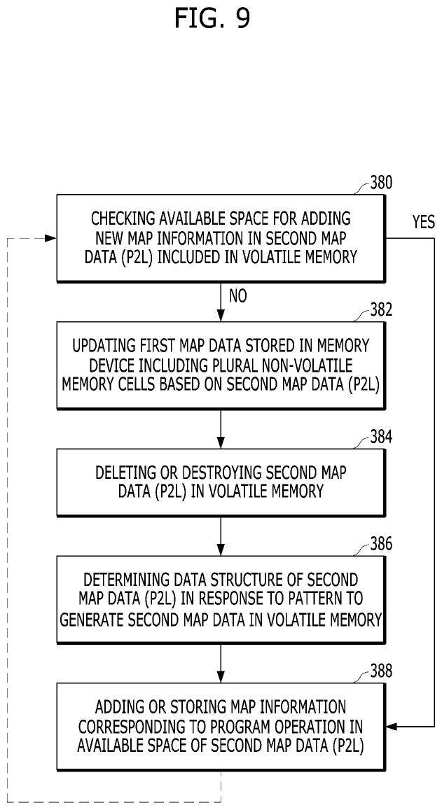

FIG. 9 illustrates another example of a method for operating a memory system according to an embodiment. Specifically, FIG. 9 shows a method for controlling and managing second map data (P2L table) included in a volatile memory in a memory system. The volatile memory may correspond to the memory 144 described with reference to FIGS. 1 to 3. The memory 144 may be implemented as a non-volatile memory having a high data input/output rate in order to improve the operation performance of the memory system 110. However, according to an embodiment, the memory 144 may include volatile memory and non-volatile memory. The controller 130 may selectively use the volatile memory or non-volatile memory based on priorities or operation margins of internal operations performed in the memory system 110.

Referring to FIG. 9, the method for operating the memory system includes checking an available space for adding new map information in the second map data (P2L table) included in the volatile memory (operation 380), updating first map data (L2P table) stored in the memory device 150 including plural non-volatile memory cells based on the second map data (P2L table) (operation 382), deleting or destroying the second map data (P2L table) in the volatile memory (operation 384), determining (or selecting) a data structure of the second map data (P2L table) in response to a pattern to generate new second map data in the volatile memory (operation 386), and adding or storing map information corresponding to a program operation in an available space of the second map data (P2L table) (operation 388).

Referring to FIGS. 1 to 3 and 8 to 9, when an piece of user data is programmed in the memory device 150, an piece of map information associated with the piece of data is generated, and the piece of map information may be recorded or stored in the second map data (P2L table). The controller 130 may check whether a new piece of map information can be stored or added in the second map data (P2L table) stored in the memory 144 (operation 380). When a new piece of map information can be added to the second map data (P2L table) (e.g., YES in operation 380), the controller 130 may record or store the new piece of map information generated in response to the program operation in the second map data (P2L table) (operation 388).

After storing the piece of map information in the second map data (P2L table), the controller 130 may perform another data input/output operation. When the controller 130 performs another program operation, another piece of map information corresponding to the corresponding program operation may be generated. When the piece of map information occurs, the controller 130 may check whether there is an available space in the second map data (P2L table) to store the corresponding map information (operation 380).

When there is no available space to store map information in the second map data (P2L table) (e.g., NO in operation 380), the controller 130 may program the second map data P2L to the memory device 150 (operation 382). This operation may be referred as to a map flush. When the second map data (P2L table) cannot store a new piece of map information, the controller 130 may determine that the second map data (P2L table) is fully filled with plural pieces of map information. The controller 130 may update the first map data (L2P table) stored in the memory device 150 based on plural pieces of map information included in the second map data (P2L table).

A method for updating the first map data (L2P table) stored in the memory device 150 may be performed whenever a piece of data is programmed in the memory device 150. However, this operation causes unnecessary processing overhead. Because the memory device 150 includes non-volatile memory cells, the memory device 150 might not support overwrite. Further, read/program operations are performed on a page-by-page basis, but erase operations may be performed on a block-by-block basis. Therefore, in order to improve the operation performance of the memory system 110, the update of the first map data (L2P table) may be delayed until plural pieces of data is programmed through the second map data (P2L table). However, when the second map data (P2L table) is fully filled with map information, the controller 130 should update the first map data (L2P table) through the map flush.

When the first map data (L2P table) is updated through the map flush, the controller 130 may delete or destroy the second map data (P2L table) in the memory 144 (operation 384). When the first map data (L2P table) is updated with the latest information through the map flush, the second map data (P2L table) in the memory 144 may no longer be needed. The controller 130 may delete or destroy the unnecessary second map data (P2L table).

The controller 130 may determine a data structure of the second map data (P2L table) in response to the pattern and generate the second map data (P2L table) having a determined data structure in the memory 144. The pattern may indicate whether plural pieces of data input/output operations are related to sequential data or random data. The data structure of the second map data (P2L table) may be determined (or selected) as one of the data structure examples shown in FIGS. 4A to 4C. After generating the second map data (P2L table) in the memory 144, the controller 130 may add, write, or store an piece of map information corresponding to the program operation in the second map data (P2L table) (operation 388).

When a voltage supplied to the memory system 110 is unstable or when the supplied voltage is suddenly stopped or interrupted, the controller 130 is configured to program the second map data (P2L table) stored in the memory 144 to the memory device 150. Because the operation margin for the controller 130 to update the first map data (L2P table) based on the second map data (P2L table) might not be secured, the second map data (P2L table) can be programmed as is to the memory device 150. When power is resumed (e.g., supplied to the memory system 110 again), the controller 130 loads the second map data (P2L table) stored in the memory device 150 into the memory 144, and then updates the first map data (L2P table) based on the second map data (P2L table) loaded in the memory 144.

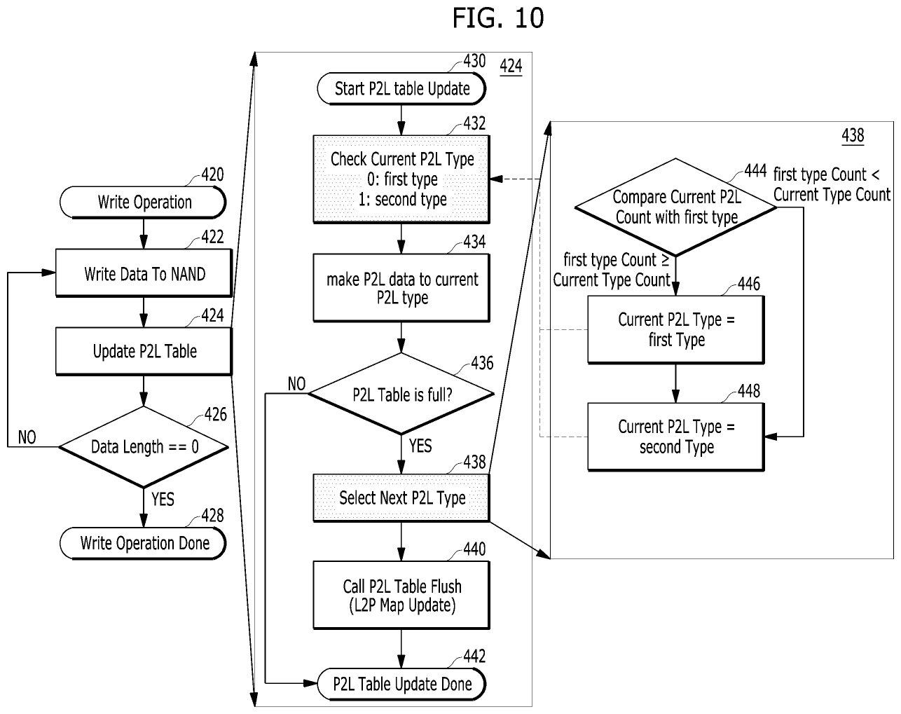

FIG. 10 illustrates a method for operating a memory system according to another embodiment. FIG. 10 specifically describes an operation in which a memory system programs a piece of data to a non-volatile memory device.

Referring to FIG. 10, the method for operating the memory system may start a write operation corresponding to a write request input from an external device (operation 420). The memory system may store a piece of data input with the write request in a memory device, e.g., a NAND device (operation 422). After storing the piece of data in the memory device, the memory system may update the second map data (P2L table) (operation 424). The memory system can check whether all pieces of data input with the write request are stored in the memory device (operation 426). When a piece of data to be stored in the memory device remains, the memory system may store a remaining piece of data in the memory device (operation 422). When there is no piece of data to be stored in the memory device, the memory system may terminate the write operation (operation 428).

In an embodiment, operation 424 for updating the second map data (P2L table) may include starting an operation for updating an piece of map information regarding the piece of data stored in the memory device to the second map data (P2L table) (operation 430). The memory system may check a data structure of the second map data (P2L table) stored in the memory 144 (operation 432). For example, the second map data (P2L table) may have the first data structure or the second data structure which is described with reference to FIGS. 4A to 4B. The memory system may convert an piece of map information regarding the piece of data stored in the memory device into a format corresponding to the data structure of the second map data (P2L table) stored in the memory 144 (operation 434). If the piece of map information is not suitable for the data structure of the second map data (P2L table), the piece of map information may be added as is to the second map data (P2L table) without conversion.

The memory system may check whether the piece of map information can be added to the second map data (P2L table) (operation 436). If the piece of map information can be added to the second map data (P2L table), the operation for updating the piece of map information to the second map data (P2L table) may be terminated (operation 442). If the piece of map information cannot be added to the second map data (P2L table), i.e., the P2L table is full, the memory system may select a data structure of the second map data (P2L table) for storing pieces of map information corresponding to write operations performed later (operation 438).

After determining the data structure of the new second map data (P2L table), the memory system may update the first map data (L2P table) based on the second map data (P2L table) previously used and filled with map information or store the second map data (P2L table) in the memory device (operation 440). The process for updating the first map data (L2P table) based on the second map data (P2L table) or storing the second map data (P2L table) in the memory device may be understood as a map flush. After a map flush, the procedure for updating the second map data (P2L table) may be terminated (operation 442).

Operation 438 for determining a data structure of the new second map data (P2L table) may include the memory system checking how many pieces of map information corresponding to the first data structure is included in the second map data (P2L table) (operation 444). Through this operation, the memory system may determine whether pieces of map information stored in the second map data (P2L table) corresponds to the first data structure more or less than the second data structure.

When the number of pieces of map information stored in the second map data (P2L table), corresponding to the first data structure, is greater than or equal to that corresponding to the second data structure, the second map data (P2L table) may continue to maintain the first data structure (operation 446). When the number of pieces of map information stored in the second map data (P2L table) corresponding to the first data structure is less than that corresponding to the second data structure, the second map data (P2L table) may have a second data structure (operation 448), e.g., the data structure of the second map data (P2L table) is changed or another data structure is selected.

Through this procedure, the memory system may determine which data structure of the second map data (P2L table) is more appropriate to store an piece of map information corresponding to a write operation that is to be subsequently performed, e.g., the first data structure or the second data structure. The data structure of the second map data (P2L table) for storing map information may be selected based on a determination result.

In accordance with one or more of the aforementioned embodiments, a memory system can change the data structure of map information temporarily stored in a cache memory or a volatile memory, thereby reducing a space allocated for the map information in the cache memory or the volatile memory. In one embodiment, a memory system may reduce the space allocated for map information in a cache memory or a volatile memory, thereby reducing power consumed in the memory system. In one embodiment, a memory system may reduce the space allocated for map information in a cache memory or a volatile memory and uses an available space for another operation performed in the memory system, thereby improving operation performance of the memory system.

While the present teachings have been illustrated and described with respect to the specific embodiments, it will be apparent to those skilled in the art in light of the present disclosure that various changes and modifications may be made without departing from the spirit and scope of the disclosure as defined in the following claims.

What is claimed is:

1. A memory system, comprising:
a memory device including a plurality of non-volatile memory cells; and
a controller configured to determine a pattern regarding a plurality of data input/output requests, control map data to have a data structure based on the pattern, and program map information included in the map data into the memory device, wherein a timing of programming the map information is based on the data structure of the map data.

2. The memory system according to claim 1, wherein the pattern indicates that the plurality of data input/output requests correspond to sequential data or random data.

3. The memory system according to claim 1, wherein the map data includes a piece of second map information that links a physical address with a logical address, wherein the second map information is distinguished from a piece of first map information, stored in the memory device, for linking a logical address to a physical address.

4. The memory system according to claim 1, wherein the data structure is one of:
a first structure including plural pieces of map information, each piece of map information associating a single physical address with a single logical address;
a second structure including plural pieces of map information, each piece of map information associating a single physical address with a start address and a continuous count of plural logical addresses or associating a single logical address with a start address and a continuous count of plural physical addresses; and
a third structure including a combination of the first structure and the second structure.

5. The memory system according to claim 3, wherein:
the memory device is configured to store first map data, the first map data including a Logical to Physical (L2P) table, the L2P table including plural pieces of first map information,
the controller is configured to load the first map data into a memory and perform address translation regarding a logical address input with one or more of the plurality of data input/output requests, and
the controller is configured to update the first map data, stored in the memory device, based on second map data including a Physical to Logical (P2L) table, the P2L table including plural piece of second map information.

6. The memory system according to claim 1, wherein the controller includes configured to:
allocate a region having a set size in a memory to store the map data, and
program the map information into the memory device after the region is fully filled with map information.

7. The memory system according to claim 1, wherein the controller is configured to:
change the data structure based on the pattern, and
program the map information, included in the map data before the data structure is changed, in the memory device after changing the data structure.

8. The memory system according to claim 1, wherein the controller is configured to determine the pattern corresponding to the plurality of data input/output requests after programming the map information in the memory device.

9. A method for operating a memory system, comprising:
determining a pattern regarding a plurality of data input/output requests;
controlling map data to have a data structure based on the pattern; and
programming map information included in the map data into a memory device including a plurality of non-volatile memory cells, wherein a timing of programming the map information is based on the data structure of the map data.

10. The method according to claim 9, wherein the pattern indicates that the plurality of data input/output requests correspond to sequential data or random data.

11. The method according to claim 9, wherein the map data includes a piece of second map information that links a physical address with a logical address, wherein the second map information is distinguished from a piece of first map information, stored in the memory device, for linking a logical address to a physical address.

12. The method according to claim 9, wherein the data structure includes one of:
a first structure including plural pieces of map information, each piece of map information associating a single physical address with a single logical address;
a second structure including plural pieces of map information, each piece of map information associating a single physical address with a start address and a continuous count of plural logical addresses or associating a single logical address with a start address and a continuous count of plural physical addresses; and
a third structure including a combination of the first structure and the second structure.

13. The method according to claim 12, further comprising:
storing first map data, the first map data including a Logical to Physical (L2P) table, the L2P table including plural pieces of first map information;
loading the first map data into a memory and performing address translation regarding a logical address input with one or more of the plurality of data input/output requests; and
updating the first map data, stored in the memory device, based on second map data including a Physical to Logical (P2L) table, the P2L table including plural pieces of second map information.

14. The method according to claim 9, further comprising:
allocating a region having a set size in a memory for storing the map data; and
programming the map information into the memory device after the region is fully filled with map information.

15. The method according to claim 9, further comprising:
changing the data structure based on the pattern; and
programming the map information, included in the map data before the data structure is changed, in the memory device after changing the data structure.

16. The method according to claim 11, further comprising:
determining the pattern regarding the plurality of data input/output requests after programming the map information in the memory device.

17. A controller which controls first map information and second map information used to associate different addresses with each other to engage plural devices that use different address systems, the controller is configured to:
determine a pattern regarding a plurality of data input/output requests;
select a data structure of map data based on the pattern, the data structure used to store a piece of second map information corresponding to a subsequent write operation;
update a piece of first map information based on the piece of second map information, wherein the piece of second map information corresponds to another write operation which has been performed; and
store the piece of second map information in the second map data having the selected data structure.

18. The controller according to claim 17, wherein:
the piece of first map information associates a logical address with a physical address, and
the piece of second map information associates the physical address with the logical address.

19. The controller according to claim 17, wherein the data structure includes one of:
a first structure including plural pieces of map information, each piece of map information associating a single physical address with a single logical address; and
a second structure including plural pieces of map information, each piece of map information associating a single physical address with a start address and a continuous count of plural logical addresses or associating a single logical address with a start address and a continuous count of plural physical addresses.

20. The controller according to claim 17, wherein the piece of first map information is updated when no more a piece of second map information is added into the second map data.
